(19) United States
(12) Patent Application Publication
(10) Pub. No.: US 2015/0039348 A1
(43) Pub. Date: Feb. 5, 2015

(54) VEHICLE OPERATIONS MONITORING

(71) Applicant: Ford Global Technologies, LLC, Dearborn, MI (US)

(72) Inventors: Kenneth James Miller, Canton, MI (US); Douglas Raymond Martin, Canton, MI (US)

(73) Assignee: Ford Global Technologies, LLC, Dearborn, MI (US)

(21) Appl. No.: 14/101,815

(22) Filed: Dec. 10, 2013

Related U.S. Application Data
(63) Continuation-in-part of application No. 13/959,057, filed on Aug. 5, 2013.

(51) Int. Cl. G06Q 40/08; G07C 5/00

(52) U.S. Cl. CPC G06Q 40/08; G07C 5/008
USPC 705/4

(57) ABSTRACT

During operation of a vehicle, usage data is received from one or more data collectors related to operation of the vehicle. A driving score is determined based on the one or more data collector inputs. A remote computer is queried for data relating the driving score to an insurance policy. During operation of the vehicle, a message is provided via a user interface based on the data relating the driving score to an insurance policy.

### RELATED APPLICATION

This application is a continuation-in-part of U.S. patent application Ser. No. 13/959057, entitled “Rapid Approach Detector,” filed Aug. 5, 2013, the contents of which are hereby incorporated herein by reference in their entirety.

### BACKGROUND

Incidents in a vehicle, such as a collision or vehicle crash incident, and also driving incidents exhibiting behaviors that may lead to collisions or crashes, may affect insurance rates and/or an ability to obtain insurance. Unfortunately, mechanisms are presently lacking for identifying events that may compromise vehicle safety and/or that may affect vehicle insurance rates, and for determining vehicle operator accountability for incidents.

### DRAWINGS

FIG. 1 is a block diagram of an exemplary system for vehicle operations monitoring.

FIG. 2 is a block diagram illustrating a first vehicle rapidly approaching a second vehicle.

FIG. 3 is a diagram of an exemplary process for identifying and reporting rapid approach incidents.

FIG. 4 is a diagram of an exemplary process for monitoring vehicle operations.

FIG. 5 is a diagram of an exemplary process that may continue from the process of FIG. 4 for monitoring and providing feedback concerning vehicle operations.

### DETAILED DESCRIPTION

### System Overview

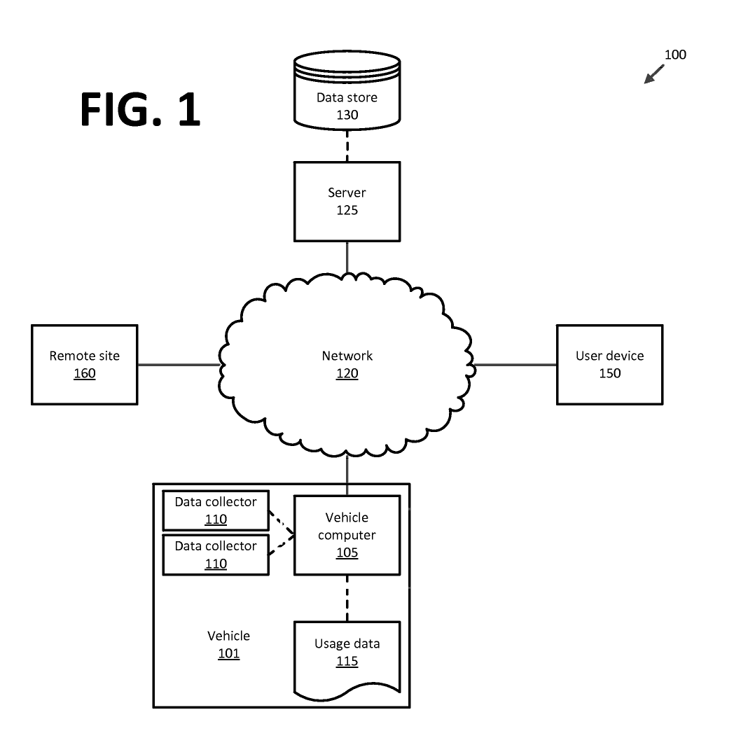

FIG. 1 is a block diagram of an exemplary system 100 for vehicle operations monitoring. A vehicle 101 includes a vehicle computer 105 that is configured to receive information, e.g., usage data 115, from one or more data collectors 110 concerning various metrics of the vehicle 101 relevant to operations of the vehicle 101, e.g., an approach of the vehicle 101 to one or more other vehicles or stationary objects, a “tailgating” distance between the vehicle 101 and one or more other vehicles, deviations of a vehicle 101 from a steady path in a roadway or a lane in a roadway, behavior of a vehicle 101 in and around intersections, etc.

For example, concerning an approach of the vehicle 101 to one or more other vehicles or objects, such metrics may include a speed (i.e., velocity) of the vehicle 101, a distance of the vehicle 101 from one or more other objects such as vehicles, stationary objects, etc. The computer 105 may also include instructions for identifying a potential collision incident, which may be reported to a server 125 via a network 120, and stored in a data store 130. Further, information related to a potential collision incident may be displayed on a display of the vehicle computer 105, a user device 150, or some other client device.

Yet further, the server 125 may use information related to a potential collision incident and/or related to operations of the vehicle 101, e.g., where an operator is operating the vehicle 101 in a manner likely to avoid collision incidents, to obtain information related to possible insurance rates and/or policies. Moreover, the server 125 may provide a vehicle 101 operator with a score or rating, and such score or rating may be shared by the vehicle 101 operator and/or automatically by the server 125 via one or more remote sites 160, e.g., social networks such as Facebook, Google+, or the like. The score or rating may be used to provide an insurance rate quote and/or adjust a rate for vehicle 101 insurance (e.g., increase or decrease a “safe driving discount”) on a real-time or near real-time basis.

### Exemplary System Elements

A vehicle 101 includes a vehicle computer 105 that generally includes a processor and a memory, the memory including one or more forms of computer-readable media, and storing instructions executable by the processor for performing various operations, including as disclosed herein. The memory of the computer 105 further generally stores usage data 115. The computer 105 is generally configured for communications on a controller area network (CAN) bus or the like. The computer 105 may also have a connection to an onboard diagnostics connector (OBD-II). Via the CAN bus, OBD-II, and/or other wired or wireless mechanisms, the computer 105 may transmit messages to various devices in a vehicle and/or receive messages from the various devices, e.g., controllers, actuators, sensors, etc., including data collectors 110. In addition, the computer 105 may be configured for communicating with the network 120, which, as described below, may include various wired and/or wireless networking technologies, e.g., cellular, Bluetooth, wired and/or wireless packet networks, etc.

Further, the computer 105 generally includes a human machine interface (HMI) that may include one or more mechanisms such as are known for a human operator of the vehicle 101 to provide input to, and receive output from, the computer 105. For example, an HMI of the computer 105 could include a touchscreen or the like providing a graphical user interface (GUI), an interactive voice response (IVR) system, and/or other lights, visual displays, sounds, haptic outputs, etc.

Data collectors 110 may include a variety of devices. For example, various controllers in a vehicle may operate as data collectors 110 to provide data 115 via the CAN bus, e.g., data 115 relating to vehicle speed, acceleration, etc. Further, sensors or the like, global positioning system (GPS) equipment, etc., could be included in a vehicle and configured as data collectors 110 to provide data directly to the computer 105, e.g., via a wired or wireless connection. Sensor data collectors 110 could include mechanisms such as RADAR, LADAR, sonar, etc., i.e., sensors that could be deployed to measure a vehicle 101 position with respect to other objects, a position in a roadway, e.g., a lane, etc. For example, a metric that could be determined by usage data 115 obtained by a sensor data collector 110 could include the distance Df, discussed further below, between the vehicle 101 and second vehicle 101, stationary object, etc.

Usage data 115 may include a variety of data collected in one or more vehicles based on operations by a particular consumer, i.e., vehicle user data 115 is generally collected using one or more data collectors 110, and may additionally include data calculated therefrom in the computer 105, and/or at the server 125. In general, usage data 115 may include any data that may be gathered by a collection device 110 and/or computed from such data, and that may be relevant to vehicle powertrain usage. For example, usage data 115 may include vehicle speed, vehicle acceleration, a distance from another vehicle 101, etc. In general, as noted below, a usage datum 115 is generally associated with a particular point in time.

The network 120 represents one or more mechanisms by which a vehicle computer 105 may communicate with a remote server 125. Accordingly, the network 120 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 125 may be one or more computer servers, each generally including at least one processor and at least one memory, the memory storing instructions executable by the processor, including instructions for carrying out various of the steps and processes described herein. The server 125 may include or be communicatively coupled to a data store 130 for storing usage data 115, records relating to potential incidents generated as described herein, etc.

A user device 150 may be any one of a variety of computing devices including a processor and a memory, as well as communication capabilities. For example, the user device 155 may be a portable computer, tablet computer, a smart phone, etc. that includes capabilities for wireless communications using IEEE 802.11, Bluetooth, and/or cellular communications protocols. Further, the user device 150 may use such communications capabilities to communicate via the network 120 and also directly with a vehicle computer 105, e.g., using Bluetooth.

A remote site 160 may be a site on the Internet, e.g., a social networking site such as Facebook, Google+, etc. Remote sites 160 may receive data from vehicle 101 operators, including usage data 115 and/or summaries thereof or messages relating thereto, and/or can provide data for display on a computer 105 HMI or a display of a device 150.

### Exemplary Process Flows

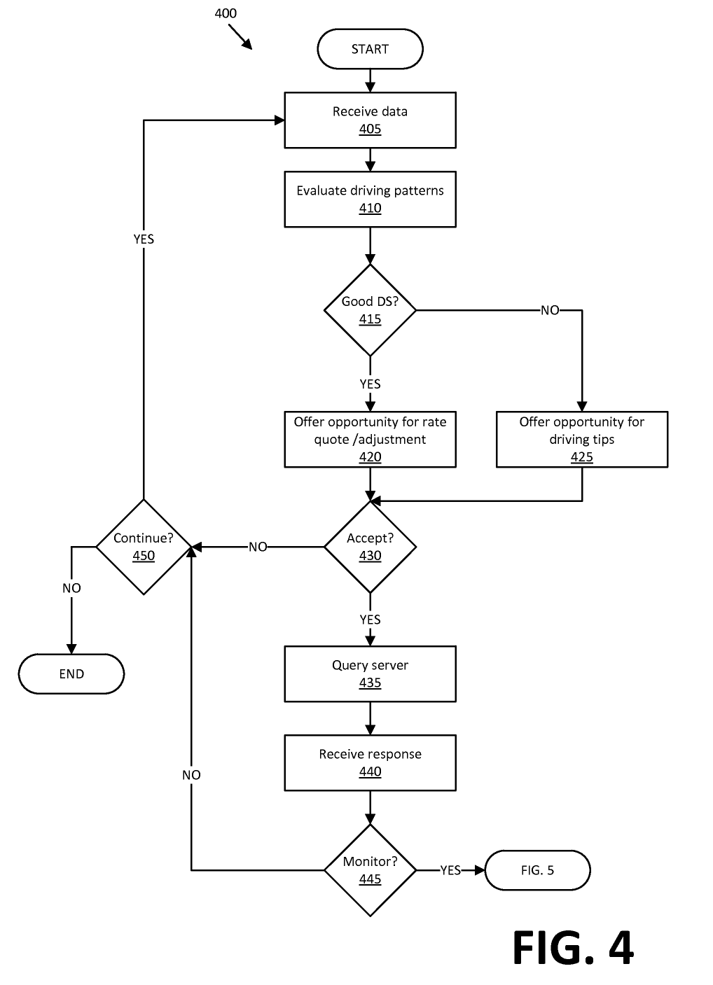

FIG. 4 is a diagram of an exemplary process 400 for monitoring vehicle 101 operations.

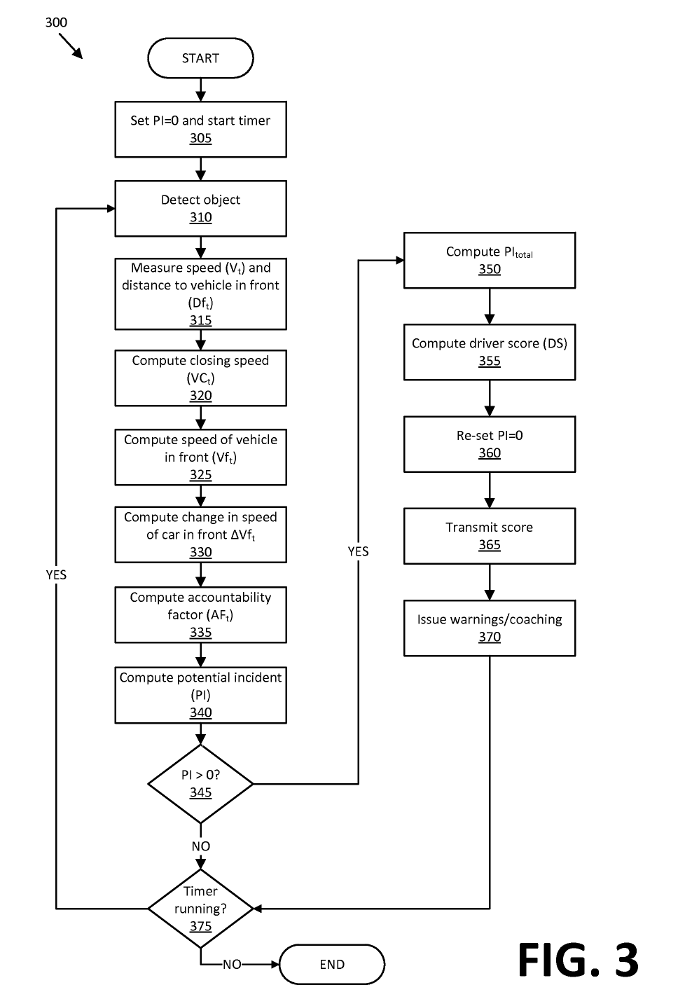

The process 400 begins in a block 405, in which the computer 105 receives data 115 from data collectors 110. Examples of such data 115 are mentioned above, and moreover, detailed examples are provided below with respect to the process 300 of FIG. 3.

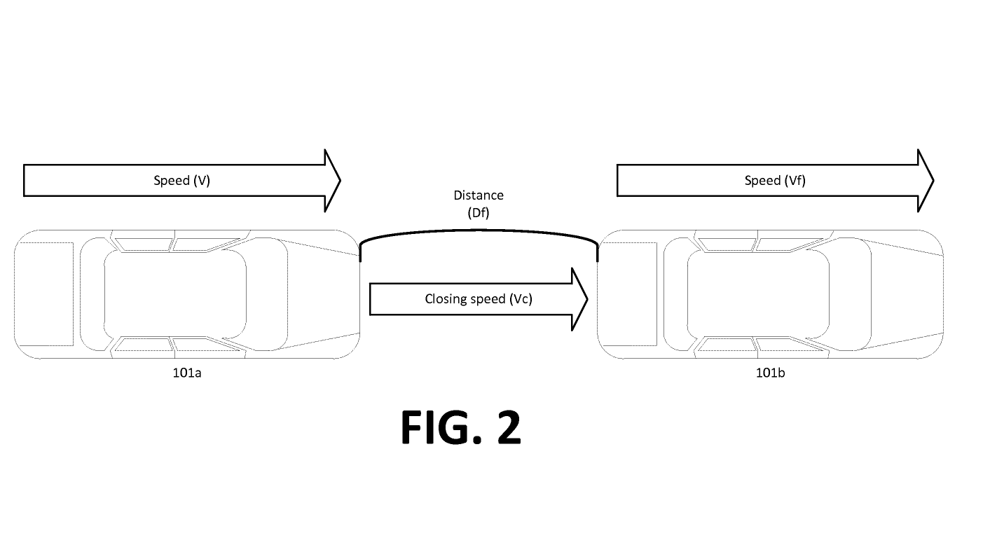

Next, in a block 410, the computer 105 evaluates driving patterns of the vehicle 101. For example, the computer 105 may attempt to identify indicia of safe and/or unsafe driving patterns, e.g., an approach of the vehicle 101 to one or more other vehicles or stationary objects where the rate of approach is more rapid than is determined to be safe, e.g., as discussed below with respect to FIGS. 2 and 3. Other examples of driving patterns for which data 115 could be evaluated include a “tailgating” distance between the vehicle 101 and one or more other vehicles that is less than such a distance should be given a speed of the vehicle 101, deviations of a vehicle 101 from a steady path in a roadway or a lane in a roadway, behavior of a vehicle 101 in and around intersections (e.g., not reducing or actually increasing speed in and through an intersection, etc.), etc.

Moreover, as mentioned above, and as discussed in detail below with respect to the exemplary process 300, the computer 105 generally also, as part of evaluation of data 115 performed in the block 410, determines a driving score or rating. A detailed example of determining a driving score DS is provided below with respect to FIG. 3.

Further, in general, the driving score may be based on a number of incidents that occur within a particular period of time and/or a magnitude of a value associated with such incidents. An incident value could have a positive magnitude if it reflects good driving behavior, and a negative magnitude if it reflects bad driving behavior. Further, a positive or negative magnitude could be determined according to a severity of an incident. For example, if a closing speed between a vehicle 101 and another object exceeded a predetermined value, and incidents value could be of a first negative magnitude, whereas if a closing speed between the vehicle 101 and another object exceeded a second predetermined value greater than the first predetermined value, then the incident value could be of a second negative magnitude having a greater absolute value than the first magnitude. Positive behavior with respect to closing speeds could similarly be quantified with incident values having positive magnitudes. In any case, if a driver has a number of rapid approach incidents in a period of time, a driving score could be computed based on the rapid approach incidents, an example of such determination being provided in more detail below with respect to FIG. 3.

Further, a plurality of driving scores may be determined for a single operator of a vehicle 101. For example, FIG. 3, discussed below, illustrates an exemplary driving score related to approach or closing speeds between a vehicle 101 and another object. Other driving scores could relate to other driver behaviors, e.g., tailgating, lane changes, lane maintenance, stopping distance, average speed relative to a posted speed limit, etc.

Next, in a block 415, the computer 105 determines whether the driving score or rating is positive or negative, i.e., whether the score reflects good or bad driving patterns. For example, the computer 105 could have stored parameters identifying a threshold or range or values for a driving score to be considered positive, negative, good, bad, etc. In some implementations, including the exemplary determination of a driving score described below with respect to FIG. 3, a driving score will be a numeric value between zero and one. Accordingly, a number between zero and one, e.g., 0.5, could provide a threshold for determining whether a driving score was in a “good” or “positive” range or in a “bad” or negative” range. Alternatively for example, a “bad” driving score could be one that is below a first threshold, e.g., 0.4, while a “good” driving score could be one that is above a certain threshold, e.g., 0.6. Driving scores at or between the two thresholds could be ignored.

Further, where the computer 105 is configured to determine a plurality of driving scores, thresholds could be different for different type or categories of driving scores. For example, a driving score related to approach speeds at or above a threshold of 0.6 could be considered “good,” whereas a driving score related to observance of posted speed limits at or above a threshold could be considered “good” if at or above a threshold of 0.5.

In general, the predetermined driving score thresholds stored in the computer 105 may be based on thresholds that have been determined to be relevant to a vehicle 101 driver's ability to obtain certain insurance policies and/or rates. For example, good driving behaviors such as maintaining safe speeds, maintaining a safe distance from other vehicles, etc., may be associated with obtaining favorable insurance policies and/or rates. Likewise, poor driving behaviors such as “tailgating,” i.e., following other vehicles too closely, maintaining unsafe speeds, etc., may prevent a vehicle 101 driver from obtaining favorable insurance policies and/or rates. Accordingly, the determination of the block 415 generally relates to identifying good and bad driving behaviors, and more particularly to driving behaviors likely to impact an ability to obtain an insurance policy and/or rates for an insurance policy.

In any event, if the driving score is positive or good, then a block 420 is executed next. If the driving score is negative or bad (or, in the present exemplary implementation, neutral), then a block 425 is executed next.

In the block 420, the computer 105, e.g., via an HMI such as discussed above, may provide a message or alert to a vehicle driver informing the driver of the determined driving score. Further, the computer 105 may, contemporaneous with vehicle 101 operations, e.g., in real-time or near real-time with determination of the driving score that is determined while the vehicle 101 is operating, offer the driver an opportunity to receive a quotation for vehicle insurance based on the driving score, and/or to have an insurance rate adjusted, including on a real-time or near real-time basis, based on the driving score. For example, the HMI could provide a message such as “Good driving score! Would you like to authorize collection of information to see if you can save money on your car insurance?” In other words, in the block 420 the HMI generally requests a user to authorize collection of information for transmission to the server 125 and/or other destinations for a determination of whether driving patterns warrant a quotation for, or adjustment of, an auto insurance rate.

In the block 425, the computer 105, e.g., via an HMI or the like, may provide a message or alert to a vehicle 101 driver informing the driver of the determined driving score, much as described above with respect to the block 420. However, in the block 425 an opportunity for an insurance rate quote and/or rate adjustment is not provided because a driving score does not suggest that a good rate would be possible unless the driving score is improved. Instead, in the block 425, the HMI may be used to provide an indication of a negative driving score and/or tips or suggestions for improving a driving score. For example, the HMI could provide a message such as “Bad driving score. To improve your driving score, do not tail other cars so closely. Would you like to authorize collection of information to see if you can improve your driving and possibly qualify for better auto insurance?” In other words, in the block 425, the HMI may inform a user of ways to improve driving patterns as well as request authorization for collecting information that could be transmitted to the server 125 and/or other destinations for determination of whether driving patterns warrant a quotation for auto insurance.

In a block 430, the computer 105 determines whether, in one of the blocks 420, 425, a user has provided input indicating authorization or acceptance of monitoring of driving patterns, e.g., to determine whether an insurance policy rate quotation may be obtained. If the vehicle 101 operator has not provided input indicating acceptance of the proposed monitoring, then the process 400 proceeds to a block 450. Otherwise, the process 400 proceeds to a block 435.

In the block 435, the computer 105 queries the server 125, e.g., via the network 120, concerning whether an advantageous rate quotation and/or rate adjustment may be obtained for the vehicle 101 operator. For example, the query may identify a make, model, year, etc. of a vehicle 101, a vehicle 101 operator age, gender, driving record information, one or more driving patterns being evaluated (e.g., approach speeds, lane maintenance, tailgating, etc.), etc. The server 125 in turn may query other computers, including one or more remote sites 160, e.g., computers maintained by insurance companies, governmental entities, etc. For example, to determine a possible rate quote or quotes, the server 125 may look for insurance policies being offered with rate discounts or advantageous rates based on one or more driving patterns, e.g., observing a speed limit, maintaining safe approach speeds, etc. The server 125 then is generally configured to determine whether an advantageous insurance policy may be possible for a vehicle 101 operator based on a driving score and/or identified driving patterns, and, if one or more possible policies are identified, to maintain information relating to specific driving patterns, e.g., specific driving scores, that would result in being able to obtain insurance policy at a certain rate. Likewise, to determine if a favorable adjustment, i.e., a discount for “safe driving” or the like, may be applied, the server 12 may evaluate the driving score and determine whether, for a current vehicle 101 and/or operator insurance policy, the driving score or scores qualify for a real-time or near real-time rate discount.

Next, in a block 440, the server 125 provides, and the computer 105 receives, a response to the query from the computer 105 made in the block 435. For example, the server 125 may inform the computer 105 whether one or more possible insurance policies have been identified based on the vehicle 101 operator's driving score and/or identified driving patterns. Further, the server 125 may include in a message to the computer 105 parameters or the like for obtaining one or more insurance policies. For example, a driving score necessary to obtain an insurance policy, and/or a particular rate, e.g., a discounted rate, for an offered policy, could be provided. Additionally and/or alternatively, a parameter for a component of a driving score could be provided, e.g., an average tailgating distance at a given speed could be specified for obtaining an insurance policy and/or rate. Likewise, as mentioned above, a plurality of driving scores could be determined for a single vehicle 101 operator, each of the plurality of driving scores relating to a particular driver behavior, e.g., tailgating, approach speed, lane maintenance, etc.

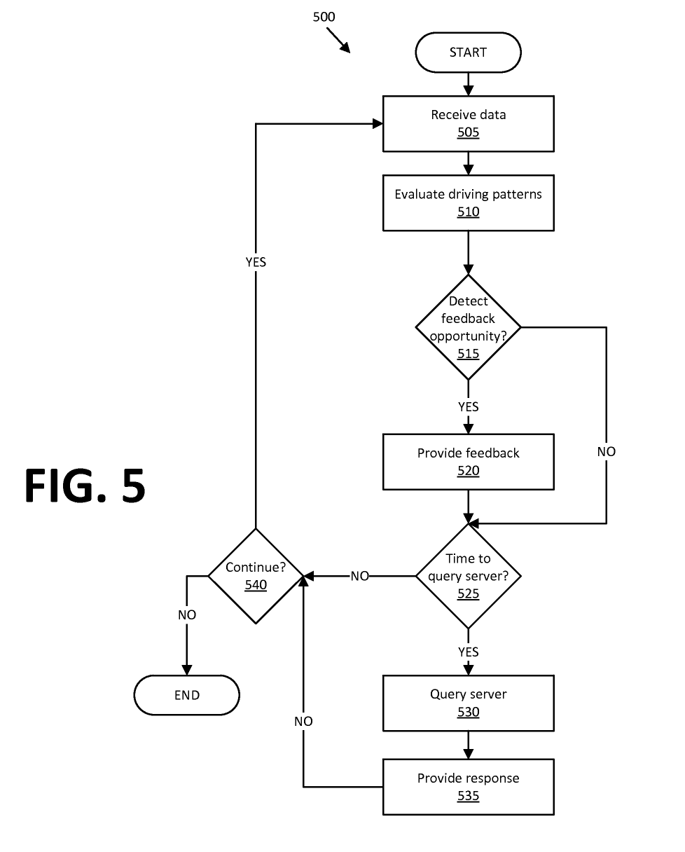

In some implementations, where a bad or negative driving score has been identified in the block 415, the blocks 435, 440 may be omitted. That is, a bad driving score indicates that a vehicle 101 operator is unlikely to be able to obtain the benefit of an advantageous insurance policy and/or rate. Therefore, it is not efficient nor likely to be beneficial to query the server 125 for insurance information. However, in such instances, as discussed below with respect to FIG. 5, the server 125 may be so queried once a driving score (or scores) has improved. Yet further alternatively, in some implementations, the process 400 may proceed directly from the block 425 to the block 450. That is, in these implementations, a vehicle 101 may be afforded the opportunity to participate in monitoring as described below with respect to FIG. 5 only when a good driving score has been recorded.

Next, in a block 445, the computer 105 determines whether to proceed with monitoring driving patterns for reporting to the server 125. For example, if no possible insurance policies and/or advantageous rates were identified by the server 125 as described above, then the computer 105 may determine not to undertake monitoring and reporting of data 115 for the server 125. If monitoring and reporting to the server 125 should not take place, then the process 400 proceeds to the block 450. However, if it is possible that a driving score determined to be a positive driving score as described above with respect to the blocks 415, 420, could result in an insurance rate quote and/or discount, or if a driving score determined to be a negative driving score as described above with respect to the block 415, 425 could be improved to result in an insurance rate quote and/or discount, then the process 400 may transition to the process 500, described below.

In the block 450, the computer 105 determines whether the process 400 should continue. For example, a vehicle 101 could be powered off, a user could provide input to stop the process 400, etc., whereupon the process 400 should end. Further, if it has been determined in the block 430 that a user does not want monitoring and reporting to the server 125, or if it is been determined in the block 445 that such monitoring and reporting will not result in an insurance rate quote, then it may be determined to end the process 400. However, it is also possible that further monitoring and evaluation of driving patterns could benefit a user, in which case the process 400 returns to the block 405.

FIG. 5 is a diagram of an exemplary process 500 for monitoring and providing feedback concerning vehicle 101 operations that may continue from the process 400 of FIG. 4, i.e., the block 445. However, the computer 105 could initiate the process 500 via an alternate mechanism, e.g., according to user input, according to an instruction or input from the server 125, etc.

The process 500 begins in a block 505, which is followed by a block 510. In the block 505, the computer 105 receives usage data 115, e.g., as described above with respect to the block 405. In the block 510, the computer 105 evaluates driving patterns and provides a driving score as described above with respect to the block 410.

Following the block 510, in a block 515, the computer 105 compares parameters for insurance policies, e.g., received as described above with respect to the process 400. For example, an insurance policy parameter may specify a driving score or the like that qualifies a vehicle 101 driver for a particular insurance policy and/or rate, e.g., a discounted rate. If a driving score is within a predetermined range of a parameter-specified driving score, the computer 105 could determine that an opportunity exists to provide feedback to a vehicle 101 operator concerning the driving score. Alternatively, if a driving score can be compared at all to a parameter-specified driving score, the computer 105 could determine that an opportunity exists to provide feedback. If feedback can be provided, then the process 500 proceeds to a block 520. However, if no parameter exist to which a driving score may be compared, then the process 500 proceeds to a block 525.

In the block 520, the computer 105 provides feedback, e.g., via an HMI in the vehicle 101, via a device 150, etc., concerning a vehicle 101 driver's performance. For example, the computer 105 could provide information relating to a trend in a particular driving score, identifying an amount of improvement and/or an area of improvement needed to qualify for an insurance rate and/or policy, etc. An exemplary message via the HMI could be one of “Congratulations! You have qualified for a special rate,” “Congratulations! You have just received a safe driving rate discount,” and “Good driving—keep maintaining a safe distance when following other cars and you will qualify for a special rate.” Alternatively, an exemplary message could state “Careful: good insurance rates are unavailable for unsafe tailgating.” Yet further alternatively or additionally, the HMI could display an amount of improvement needed, e.g., “To improve your driving score, increased tailgating distance by 10 yards at highway speeds.”

In the block 525, the computer 105 determines whether the server 125 should be queried for updated insurance policy information. For example, the computer 105 could be configured to query the server 125 periodically, e.g., once per day, once per week, etc., and/or according to an amount of time the vehicle 101 is operated, e.g., every five hours of operations, 10 hours of operations, etc. If the server should be queried, then the process 500 proceeds to a block 530. Otherwise, a block 540 is executed next.

In the block 530, the computer 105 queries the server 125, e.g., for updated insurance policy information such as was described above concerning the block 435.

In the block 440, which follows the block 530, the computer 105 receives a response from the server 125, and displays any appropriate information via an HMI, via the device 150, etc. For example, if a vehicle 101 driver has qualified for an insurance policy and/or rate discount, the computer 105 could provide a message so indicating in real-time or near real-time (i.e., within seconds or minutes of a query having been provided to the server 125). Likewise, the computer 105 could provide a message indicating a user is close to qualifying for an insurance policy and/or rate discount, e.g., safe driving for another period of time, e.g., 20 driving hours, etc., may so qualify the user.

Following either the block 525 with a block 535, the block 540 may be executed. In the block 540, similar to the block 450 described above, the computer 105 determines whether the process 500 should continue. If so, the process 500 returns to the block 505. Otherwise, the process 500 ends.

FIG. 2 is provided to illustrate a scenario under which the exemplary process 300, discussed below with respect to FIG. 3, for identifying and reporting rapid approach incidents, may be conducted. FIG. 2 is a block diagram illustrating a first vehicle 101a approaching a second vehicle 101b. As illustrated in FIG. 2, the first vehicle 101a may be traveling at a first speed (denoted by V), while the second vehicle may be traveling at a second speed (denoted by Vf). A distance (denoted Df) from the first vehicle 101a to the second vehicle 101b, which is in this example in front of the first vehicle 101a, may be measured by one or more data collectors 110, as discussed below. Based on the two vehicles' respective velocities and the distance Df, a closing speed Vc, i.e., a rate of speed at which the vehicles 101 are approaching one another, may be calculated. The closing speed Vc and other factors as discussed below may be used to determine whether a potential incident, e.g., a potential collision incident, should be identified.

FIG. 3 is a diagram of an exemplary process 300 for identifying and reporting rapid approach incidents. However, it is to be understood that some or all of the process 300 could be alternatively or additionally applied to other kinds of incidents. For example, tailgating incidents, lane deviation incidents, etc., could be could be detected and/or included in a computation of the driving score DS discussed with respect to the process 300. Certain data 115 and/or calculations would be different for a driving score DS based in whole or in part on other kinds of incidents, but other portions of the process 300 could be largely as described and illustrated herein.

The process 300 begins in a block 305, in which a “potential incident” variable PI is initialized to a value of zero, and a timer is started. Further, a variable PIₜₒₜₐₗ, discussed further below, is also initialized to a value of zero. Generally, the process 300 begins, and the timer is started, when a driving session begins, e.g., when a vehicle 101 is started, whereupon the computer 105 is booted. Accordingly, the timer provides a count of time, e.g., provides a series of time indices, beginning with the start of a driving session.

Next, in a block 310, data collectors 110 provide data to the computer 105 indicating that an object has been detected proximate to the vehicle 101. For purposes of the block 310, “proximate” could be defined as a distance threshold, e.g., five feet, 10 feet, 50 feet, etc. In general, the other object may be another vehicle, but the other object could also be a stationary or slow-moving object such as a person, a building, a tree, fence, etc.

Next, in a block 315, the computer 105 obtains, e.g., via CAN bus communications or the like, a measurement of velocity of the vehicle 101 at a current time indicated by the timer (Vₜ). Further, the computer 105 obtains, e.g., from a data collector 110 such as a RADAR device, a LADAR device, etc., a measurement of distance (Df) between the vehicle 101 and the object detected in the block 310. Moreover, as will be seen below, e.g., with respect to the block 320, the computer 105 generally makes multiple measurements of the distance between the vehicle 101 in the object at different times, e.g., Dfₜ, Dfₜ₋₁, where Dfₜ represents a current or most recent distance measurement, and Dfₜ₋₁ represents a previous distance measurement. For example, the difference between a times t and t−1 may be 1 second.

Next, in a block 320, the computer 105 computes a closure velocity (VC) between the vehicle 101 and the object. For example, the closure velocity at a time t could be computed according to the formula:

VCₜ=(Dfₜ,−Dfₜ₋₁)/[t−(t−1].

Thus, if Dfₜ was 100 feet, and Dfₜ₋₁ was 99 feet, and the difference between t and t−1 was one second, then the closure speed or velocity VC would be one foot per second, or 0.68 miles per hour (m.p.h.).

Next, in a block 325, the computer 105 computes a velocity (Vf) of the object, e.g., another vehicle that is in front of the vehicle 101. The velocity Vf may be computed by adding the velocity of the vehicle 101 to the closure velocity, e.g., according to the formula:

Vfₜ=Vₜ+VCₜ.

Next, in a block 330, the computer 105 determines a rate of change of speed ΔVfₜ, i.e., acceleration or deceleration, of the object. As discussed further elsewhere herein, e.g., with respect to the block 335, computing the rate of change of speed of the other vehicle or object, in addition to the closure velocity and the velocity of the vehicle 101 can be important in determining whether a potential incident should be identified. For example, a car may stop very suddenly in front of a vehicle 101, i.e., the rate of change of speed of the front car may be a rapid deceleration, in which case an operator of the vehicle 101 may be relatively blameless for a collision or potential collision. A value for the object's rate of change of speed may be computed according to the formula:

ΔVfₜ=Vfₜ−Vfₜ₋₁.

Of course, this value could be zero, e.g., if the object is a stationary object or a vehicle is not changing speed.

Next, in a block 335, the computer 105 computes an accountability factor (AF), which is a value reflecting a degree to which a vehicle 101 operator should be held accountable for a potential incident, as opposed to a degree to which the behavior of the object, e.g., another vehicle, being approached, is responsible for the potential incident, e.g., because of rapid braking, rapid reverse, etc. In one implementation, the accountability factor AF includes two components, or sub-factors: AF1, which is a function of the object's velocity Vfₜ, and AF2, which is a function of the object's change of rate of speed ΔVfₜ. Examples of the functions for AF1 and AF2 include, where the functions may further provide that values for Vfₜ, and ΔVfₜ below certain respective thresholds, e.g., <−15 m.p.h., or ΔVfₜ<−10 miles per hour per second, respectively result in values of zero for AF1 and AF2. The accountability factor AF may then be computed based on values of its components, e.g., as a simple product according to the formula:

AF=AF1*AF2.

In general, an accountability factor may be the product of two or more accountability sub-factors AF1*AF2* . . . AFn. A first accountability sub-factor, AF1, may be a function on the speed that the object, e.g., a vehicle in front of the vehicle 101, is going in reverse (e.g., a vehicle in front going −15 m.p.h. in reverse removes accountability, i.e., AF1=0). As another example, the value of AF1 could be 1.0 where the object, e.g., another vehicle, was not moving. Yet another example may have AF1 at a value of 0.5 if the vehicle in front was moving in reverse at 5 m.p.h. Further for example, as shown in Table 1, an accountability factor AF1 could be a function of the velocity of the object, e.g., vehicle in front:

TABLE 1

| Vf (in m.p.h.) | 0 | −2.5 | −5 | −10 | −15 |
|---|---|---|---|---|---|
| AF1 | 1 | 0.75 | 0.5 | 0.25 | 0 |

A second exemplary accountability factor, AF2, could be a function on the deceleration rate of the object, e.g., a vehicle in front decreasing speed by 10 m.p.h. within 1 second could remove accountability, i.e., AF2=0. As another example, the values of AF1 and AF2 could each be 1.0 where the object, e.g., other vehicle, was not moving. Yet another example may have AF2 at a value of 0.5 if the vehicle in front was decelerating by 5 m.p.h. within 1 second. Further for example, as shown in Table 2, an accountability factor AF2 could be a function of the rate of change in velocity of the object, e.g., vehicle in front:

TABLE 2

| ΔVf (m.p.h./per sec.) | 0 | −5 | −10 | −15 | −20 |
|---|---|---|---|---|---|
| AF2 | 1 | 0.75 | 0.5 | 0.25 | 0 |

Other accountability factors (AF3 . . . AFn) are also possible, and could be based on factors such as a vehicle that unexpectedly enters the lane of the vehicle 101, detected road obstacles, etc.

Next, following the block 335, in a block 340, the computer 105 computes a potential incident (PI) value related to the time t. For example, the PI value could be computed according to logic that maintains the PI value at zero unless the closure speed VCₜ exceeded a certain threshold, e.g., 20 miles per hour, and the distance Df between the vehicle 101 and the object fell below a certain threshold, e.g., 100 feet. In one implementation, PI could be computed according to the product of the accountability factor (AF) and an incident value (IV), e.g., according to the formula:

PI=AF*IV.

The incident value (IV) is generally a function on the closure speed (CS) and the distance to the object (Df). For example, Table 3 provides values that could be provided for such a function:

TABLE 3

Closing Speed CS (m.p.h.)

| | | 0 | 2.5 | 5 | 10 | 20 | 30 |
|---|---|---|---|---|---|---|---|
| Df (ft.) | 100 | 0 | 0 | 0 | 0 | 0 | 0 |
| | 75 | 0 | 0 | 0 | 0 | 0.25 | 0.5 |
| | 50 | 0 | 0 | 0 | 0.5 | 0.5 | 1 |
| | 25 | 0 | 0 | 0 | 0.25 | 1 | 1 |
| | 0 | 0 | 0 | 0.5 | 1 | 1 | 1 |

Next, in a block 345, the computer 105 determines whether the potential incident value PI is greater than zero. If yes, a block 350 is executed next. Otherwise, the process 300 proceeds to a block 375.

In the block 350, the computer 105 computes a total potential incident value PIₜₒₜₐₗ, generally according to the formula:

PIₜₒₜₐₗ=PIₜₒₜₐₗ+PI.

Following the block 350, next, in a block 355, the computer 105 computes a driving score DS for an operator of the vehicle 101. In one implementation, a driving score is an indicator of an average driving time between potential incidents. Accordingly, where a total drive time for a driving session, e.g., the time (T) elapsed on the timer initiated in the block 305, a formula for a driving score DS may be:

DS=T/PIₜₒₜₐₗ.

Next, in a block 360, the variable PI is re-set to zero.

Next, in a block 365, the value for the driving score DS is transmitted to the server 125. Further, other usage data 115 may be transmitted to the server 125 as a record of an operator's driving habits, e.g., average speeds, distances traveled, instances of acceleration or deceleration exceeding a certain threshold, etc.

Next, in a block 370, much as described above with respect to the processes 400, 500, the computer 105 may provide a warning or notification to an operator of the vehicle 101, e.g., via a display in the vehicle 101 connected to the computer 105, via a user device 150, via a messaging mechanism such as email or short message service (SMS) messaging, etc. In any case, such warning, message, or notification may reflect the value of the driving score. For example for a driving score that is poor, e.g., where DS<1, a message could provide a notification such as “Poor driving score. You could improve your score if you more closely match the speed of the car in front of you,” or “Poor driving score. You could save money on insurance if you more closely match or speed to that of the car in front of you.” Similarly, a notification could be provided advising of a good driving score.

Following either the block 370 or the block 345, the block 375 may be executed. In the block 375, the computer 105 determines whether the timer initiated in the block 305 continues to run, that is whether a driving session continues. If it does not, or, alternatively, if a vehicle 101, including the computer 105, is powered off, the process 300 ends. Otherwise, the process 300 returns to the block 310.

### CONCLUSION

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising a computer in a vehicle, the computer comprising a processor and a memory, wherein the computer is configured to:
during operation of the vehicle, receive usage data from one or more data collectors related to operation of the vehicle;
determine a driving score based on the one or more data collector inputs;
query a remote computer for data relating the driving score to an insurance policy; and
during operation of the vehicle, provide a message via a user interface based on the data relating the driving score to an insurance policy.

2. The system of claim 1, wherein:
the message includes a request to provide the usage data to the remote computer; and
the computer is further configured to provide the usage data to the remote computer after receiving user authorization.

3. The system of claim 2, wherein the computer is further configured to receive insurance policy information based on the usage data.

4. The system of claim 2, wherein the computer is further configured to submit the usage data to the remote computer and receive and display the insurance policy information in real-time or near real-time.

5. The system of claim 1, wherein the message includes an evaluation of operation of the vehicle.

6. The system of claim 1, wherein the computer is further configured to:
determine an accountability factor reflecting a degree to which an operator of the vehicle should be held accountable for a potential incident, and an incident value for the potential incident; and
determine the driving score based on the accountability factor and a value assigned to the potential incident.

7. The system of claim 6, wherein the accountability factor is the product of two or more accountability sub-factors.

8. The system of claim 6, wherein at least one of the accountability sub-factors is a function of a reverse speed of an object or a deceleration rate of the object.

9. The system of claim 1, wherein the computer is further configured to determine a plurality of driving scores.

10. The system of claim 1, wherein the data relating the driving score to an insurance policy includes one of an insurance rate quote and an adjustment to a rate of an existing policy.

11. A method, comprising:
during operation of a vehicle, receiving usage data from one or more data collectors related to operation of the vehicle;
determining a driving score based on the one or more data collector inputs;
querying a remote computer for data relating the driving score to an insurance policy; and
during operation of the vehicle, providing a message via a user interface based on the data relating the driving score to an insurance policy.

12. The method of claim 11, wherein the message includes a request to provide the usage data to the remote computer, the method further comprising providing the usage data to the remote computer after receiving user authorization.

13. The method of claim 12, further comprising receiving insurance policy information based on the usage data.

14. The method of claim 12, further comprising submitting the usage data to the remote computer and receiving and displaying the insurance policy information in real-time or near real-time.

15. The method of claim 11, wherein the message includes an evaluation of operation of the vehicle.

16. The method of claim 11, further comprising:
determining an accountability factor reflecting a degree to which an operator of the vehicle should be held accountable for a potential incident, and an incident value for the potential incident; and
determining the driving score based on the accountability factor and a value assigned to the potential incident.

17. The method of claim 16, wherein the accountability factor is the product of two or more accountability sub-factors.

18. The method of claim 16, wherein at least one of the accountability sub-factors is a function of a reverse speed of an object or a deceleration rate of the object.

19. The method of claim 11, further comprising determining a plurality of driving scores.

20. The method of claim 11, wherein the data relating the driving score to an insurance policy includes one of an insurance rate quote and an adjustment to a rate of an existing policy.
